(19) United States
(12) Patent Application Publication
(10) Pub. No.: US 2012/0121785 A1
(43) Pub. Date: May 17, 2012

(54) METHOD OF PREPARING AND DISPENSING FOOD PRODUCTS

(76) Inventors: Peter Burn, Leeds (GB); Anthony Hitchen, Wigan (GB)

(21) Appl. No.: 13/297,325

(22) Filed: Nov. 16, 2011

(30) Foreign Application Priority Data
Nov. 16, 2010 (GB) GB 1019351.4

(51) Int. Cl. A21D 2/00; A21D 6/00; B65B 69/00; B65D 81/34; B65B 29/08

(52) U.S. Cl. 426/552; 426/420; 426/393; 426/389; 426/558

(57) ABSTRACT

A container is partially filled with a raw cake batter. A lower portion of the container is covered by said batter and an upper portion of the container defines a void into which the cake batter can expand during baking The partially-filled container is frozen at the charging location. The container is then shipped under chilled conditions and presented for retail at said retail location in a chilled, substantially unfrozen state. The container is then purchased and placed directly into an oven without further preparation, in order to produce a freshly baked cake in said container.

### CROSS-REFERENCE TO RELATED APPLICATIONS

This application claims priority to GB 1019351.4 filed on Nov. 16, 2010, the entire contents of which are hereby incorporated by reference.

### TECHNICAL FIELD

The present invention relates to methods of preparing and dispensing food products. More particularly, but not exclusively, the invention relates to a method of preparing and dispensing an oven-baked cake.

### BACKGROUND

There can be few people who do not enjoy the smell of a freshly baked bread or cake. However, changes in lifestyle over the past two decades have led to a decline in the number of people who bake bread or cakes at home.

In recent years, the availability of domestic bread making machines has seen an increase in the number of people baking their own bread. However, despite the availability of pre-packaged cake mixtures, the same increase has not been seen in domestic cake baking

Accordingly, an object of the invention is to provide a method and/or apparatus which seeks to address this disparity, and/or one or more other disadvantages associated with known cake making methods.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

According to one aspect of the invention, there is provided a method of preparing and dispensing an oven-baked cake, the method including the steps of providing a container for the baking of a cake in an oven; charging said container with unbaked cake mixture at a charging location; packaging the charged container; and presenting the packaged and charged container for purchase at a retail location prior to baking in an oven; wherein the charged container is available for baking said unbaked cake mixture in said container in an oven at a dispensing location which is remote from the retail location and for dispensing from the container at said dispensing location after baking.

The method provides an opportunity for consumers to bake their own cake without the need for preparation of cake ingredients or receptacles for said ingredients. Rather, the charged container (including the unbaked cake mixture) can be purchased and then placed in a heated oven for a predetermined period of time at the consumer's home, whereby the unbaked cake mixture is transformed into a fresh oven-baked cake in the container, providing both aesthetic and sensual appeal.

In exemplary embodiments, the container is charged at a charging location and then frozen (e.g. at the charging location), in order to freeze the unbaked cake mixture in the container. This has the benefit of prolonging the shelf-life of the unbaked cake mixture.

In exemplary embodiments, the container (including the unbaked cake mixture) is packaged (e.g. in a sealed container or wrapping or the like) at the charging location. This packaging step may occur prior to, during or after the freezing stage. In exemplary embodiments, the packaging step occurs after the freezing step.

In exemplary embodiments, the charged container is packaged with additional ingredients intended to be applied to the cake after baking, e.g. a cream-type product or icing or syrup or the like intended to be applied to the upper surface of the cake after baking In exemplary embodiments, the additional ingredients are sealed in a container, and said container is stored for transport and retail with said charged container inside said packaging, e.g. a box or like receptacle for enclosing the charged container and said container. Said container may take the form of a sealed pouch or sachet or the like, for example. The additional ingredients may be frozen prior to transportation of said packaging to said retail location.

In exemplary embodiments, the charged container is packaged with additional ingredients intended to be applied to the unbaked cake mixture prior to baking, e.g. fruit pieces or pieces of confectionary, such as chocolate chips or the like. In exemplary embodiments, the additional ingredients are sealed in a container, and said container is stored for transport and retail with said charged container inside said packaging, e.g. a box or like receptacle for enclosing the charged container and said container. Said container may take the form of a sealed pouch or sachet or the like, for example. The additional ingredients may be frozen prior to transportation of said packaging to said retail location.

The charged container (including the frozen unbaked cake mixture) may be shipped in a frozen or chilled condition for storage at the retail location. The unbaked cake mixture may be stored in the container at the retail location in a frozen or chilled condition.

In exemplary embodiments, the frozen container (including the frozen unbaked cake mixture) is transported to said retail location via a chilled distribution chain (e.g. in a chilled container on a road or rail vehicle). Freezing the ingredients in the container before transportation has the added benefit of providing rigidity to the unbaked mixture, which reduces the risk of unwanted displacement of the unbaked cake mixture during transportation. This is particularly important for embodiments in which the charged container is only partially filled with the unbaked cake mixture (e.g. less than 80% filled), to avoid or minimise the deposition of the cake mixture onto the uncovered side walls of the container during transportation, especially if the unbaked cake mixture is a cake batter of pourable or gel-like consistency. Furthermore, transportation of the charged containers via a chilled distribution chain provides tempering time for the frozen unbaked cake mixture prior to arrival at said retail location.

In exemplary embodiments, the unbaked cake mixture is presented for retail in a chilled cabinet (as opposed to a freezer cabinet). Hence, the charged container is intended to be purchased in a substantially unfrozen, chilled state. In exemplary embodiments, the charged and frozen containers are distributed via a chilled distribution chain and presented for retail in a chilled cabinet (as opposed to a freezer cabinet) in a substantially unfrozen, chilled state. The charged containers are delivered to the retail location via the chilled distribution chain and may need to be held in storage (e.g. chilled storage) at the retail location prior to supply to the chilled cabinet, to ensure that the charged containers are presented for retail in a substantially unfrozen, chilled state.

In other embodiments, the unbaked mixture is frozen in the container after charging, the charged container is then transported in a frozen condition to the retail location and stored in a frozen condition at the retail location for retail in a frozen condition. In this embodiment, the charged and frozen container may be placed directly in an oven for baking the ingredients from frozen at the dispensing location.

In other embodiments, the unbaked mixture is frozen in the container after charging, the charged container is then transported in a frozen condition to the retail location and stored in a chilled condition at the retail location for retail in a chilled condition. In this embodiment, the charged and chilled container may be placed directly in an oven for baking the ingredients from a chilled or ambient state after purchase and removal from the retail location, or may be placed in a freezer for further storage in a frozen state at the dispensing location, prior to baking from frozen.

In further embodiment, the unbaked mixture is frozen in the container after charging, the charged container is then transported in a chilled condition to the retail location and stored in a chilled condition at the retail location for retail in a chilled condition. In this embodiment, the consumer may place the charged and chilled container directly in an oven for baking the ingredients from a chilled or ambient state after purchase and removal from the retail location, or may place the container in a freezer for further storage in a frozen state at the dispensing location, prior to baking from frozen.

In yet a further embodiment, the unbaked mixture is chilled in the container after charging, the charged container is then transported in a chilled condition to the retail location and stored in a chilled condition at the retail location for retail in a chilled condition. In this embodiment, the consumer may place the charged and chilled container directly in an oven for baking the ingredients from a chilled or ambient state after purchase and removal from the retail location, or may place the container in a freezer for further storage in a frozen state at the dispensing location, prior to baking from frozen.

In an example, the container is a single use container, wherein the cake is baked in the container and dispensed from the container, before the container is disposed of.

The container may take the form of a body of paper or board type material. The container may be of a table-ready construction, whereby the cake can be presented for consumption from said container after baking.

In exemplary embodiments, the container defines an open topped enclosure for receiving the unbaked cake mixture. In exemplary embodiments, the container has a side wall which is self supporting, so as to be generally upright prior to charging with the unbaked cake mixture. The container is configured to be suitably rigid, for preventing substantial deformation as a result of expansion of the cake mixture during baking of the cake. In exemplary embodiments, the container is only part-filled with the unbaked cake mixture (e.g. less than 80% filled). Hence, the charged, part-filled container defines space into which the cake mixture may expand during baking of the cake. The sides of the container are configured to constrain expansion of the cake mixture to an upward direction within the container during baking

In exemplary embodiments, the container has a base and a side wall. The base may be provided with a silicon coating or other means suitable for preventing significant deterioration of the base during storage of the unbaked cake mixture (e.g. as a result of moisture damage). The side wall may be provided with a greaseproof coating or other means suitable for promoting ready separation of the cake from the side wall after baking

In exemplary embodiments, the unbaked cake mixture is charged into said container in a raw state (e.g. as a cake batter). In exemplary embodiments, the unbaked cake mixture is of a formulation which is edible in a raw chilled state prior to baking For example, the formulation of the raw cake batter may be selected to be edible (i.e. not harmful) if consumed raw, at least in small quantities, particularly within a known time frame (e.g. a within a ‘best before’ date). This is particularly important for embodiments in which the charged container is open topped, where a user, children or other persons may have access to the charged container prior to baking For instance, the unbaked cake mixture may include one or more from the following list of ingredients: egg, flour, milk; wherein the or each of said ingredients from said list is heat-treated prior to baking in the container (e.g. prior to charging of said unbaked cake mixture into the container), in order to be edible prior to baking The milk may be provided in the form of UHT milk or UHT milk powder. The flour may be provided in the form of a heat treated flour. The egg may be provided in the form of a fully pasteurised egg product. In other embodiments, said list of ingredients may be mixed together and then heat treated prior to charging into said container.

In exemplary embodiments, the unbaked cake mixture is configured to control water activity for preventing or minimising the migration of water from within the cake batter.

In exemplary embodiments, the unbaked cake mixture includes a baking powder or other chemical leavening agent for increasing the volume of the cake mixture during baking In exemplary embodiments, the baking powder/leavening agent is microencapsulated or otherwise configured to remain inactive in the absence of sufficient heat. This prevents or reduces the risk of undesired activation of the baking powder/leavening agent within the cake mixture prior to baking in the container.

Another aspect of the invention provides a method of preparing an oven-baked cake, the method including the steps of providing a container for the baking of a cake in an oven; charging said container with unbaked cake mixture at a charging location; and presenting the charged container for purchase at a retail location remote from said charging location prior to baking in an oven; wherein the container is of the kind having a base and a side wall extending up from said base, and defines an open chamber for receiving the unbaked cake mixture; wherein the unbaked cake mixture is charged into said container in the form of a raw cake batter suitable for eating in a raw chilled state; wherein the step of charging the container results in only a partial filling of said open chamber with said raw cake batter, such that only a lower portion of the side wall is covered by said raw cake batter and an upper portion of the side wall defines part of a void into which the cake batter can expand during baking; wherein the partially-filled container is frozen at said charging location to freeze the raw cake batter in said partially-filled container prior to shipping to said retail location; and wherein the partially-filled container is presented for retail at said retail location in a chilled, substantially unfrozen state ready for baking at a baking location remote from said retail location.

A further aspect of the invention provides an apparatus for dispensing an oven-baked cake, including a container charged with unbaked cake mixture, wherein the charged container is packaged for transportation and for sealed storage of the unbaked cake mixture in the container at a retail location, and wherein the container is a single use container configured for placing in an oven at a dispensing location remote from said retail location for converting the unbaked cake mixture into a fresh oven baked cake in the container and for disposal of the container after dispensing the cake from the container.

In an example, the container is a single use container, wherein the cake is baked in the container and dispensed from the container, before the container is disposed of.

The container may take the form of a body of paper or board type material. The container may be of a table-ready construction, whereby the cake can be presented for consumption in said container after baking

In exemplary embodiments, the container defines an open topped enclosure for receiving the unbaked cake mixture. In exemplary embodiments, the container has a side wall which is self supporting, so as to be generally upright prior to charging with the unbaked cake mixture. The container is configured to be suitably rigid, for preventing substantial deformation as a result of expansion of the cake mixture during baking of the cake. In exemplary embodiments, the container is only part-filled with the unbaked cake mixture (e.g. less than 80% filled). Hence, the charged, part-filled container defines space into which the cake mixture may expand during baking of the cake. The sides of the container are configured to constrain expansion of the cake mixture to an upward direction within the container during baking

In exemplary embodiments, the container has a base and a side wall. The base may be provided with a silicon coating or other means suitable for preventing significant deterioration of the base during storage of the unbaked cake mixture (e.g. as a result of moisture damage). The side wall may be provided with a greaseproof coating or other means suitable for promoting ready separation of the cake from the side wall after baking

In exemplary embodiments, the unbaked cake mixture is charged into said container in a raw state (e.g. as a cake batter). In exemplary embodiments, the unbaked cake mixture is of a formulation which is edible in a raw chilled state prior to baking For example, the formulation of the raw cake batter may be selected to be edible (i.e. not harmful) if consumed raw, at least in small quantities, particularly within a known time frame (e.g. a within a ‘best before’ date). This is particularly important for embodiments in which the charged container is open topped, where a user, children or other persons may have access to the charged container prior to baking For instance, the unbaked cake mixture may include one or more from the following list of ingredients: egg, flour, milk; wherein the or each of said ingredients from said list is heat-treated prior to baking in the container (e.g. prior to charging of said unbaked cake mixture into the container), in order to be edible prior to baking The milk may be provided in the form of UHT milk or UHT milk powder. The flour may be provided in the form of a heat treated flour. The egg may be provided in the form of a fully pasteurised egg product. In other embodiments, said list of ingredients may be mixed together and then heat treated prior to charging into said container.

In exemplary embodiments, the unbaked cake mixture is configured to control water activity for preventing or minimising the migration of water from within the cake batter.

In exemplary embodiments, the unbaked cake mixture includes a baking powder or other chemical leavening agent for increasing the volume of the cake mixture during baking In exemplary embodiments, the baking powder/leavening agent is microencapsulated or otherwise configured to remain inactive in the absence of sufficient heat. This prevents or reduces the risk of undesired activation of the baking powder/leavening agent within the cake mixture prior to baking in the container.

### BRIEF DESCRIPTION OF THE DRAWINGS

Other aspects and features of the invention will be apparent from the following description of exemplary embodiments, made by way of example only, with reference to the accompanying drawings, in which:

FIG. 1 is a schematic cross-sectional side view of a container and a charging vessel for charging the container with food product;

FIG. 2 is a schematic cross-sectional side view of the container of FIG. 1 in a charged and packaged state;

FIG. 3 is a schematic cross-sectional side view of a cake baked in the container of FIGS. 1 and 2;

FIG. 4 is a schematic plan view of the container charged with food product including a ring of pineapple; and

FIG. 5 is a schematic plan view of the container charged with food product including a plurality of chocolate pieces.

### DETAILED DESCRIPTION

The presently disclosed invention is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies.

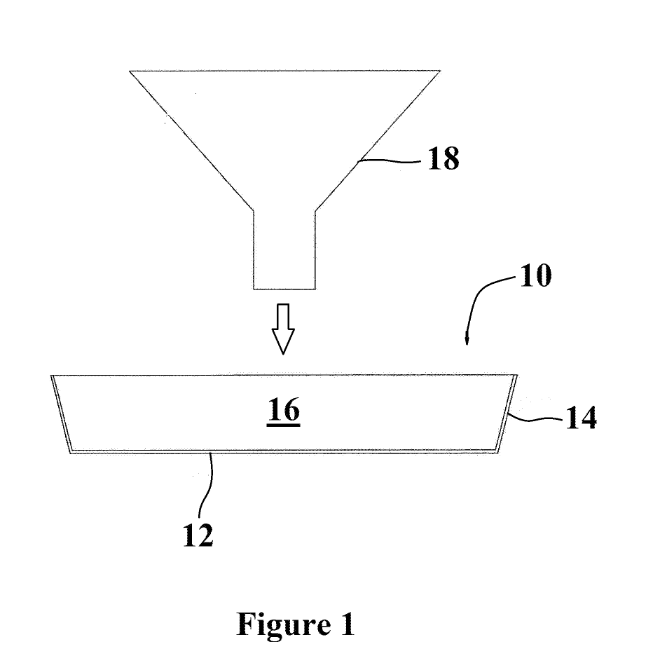

Referring firstly to FIG. 1, there is shown a container 10 for the baking of a cake in an oven. The container 10 has a base 12 and side wall 14 extending up from said base 12. The base 12 and side wall 14 define an open-topped chamber 16.

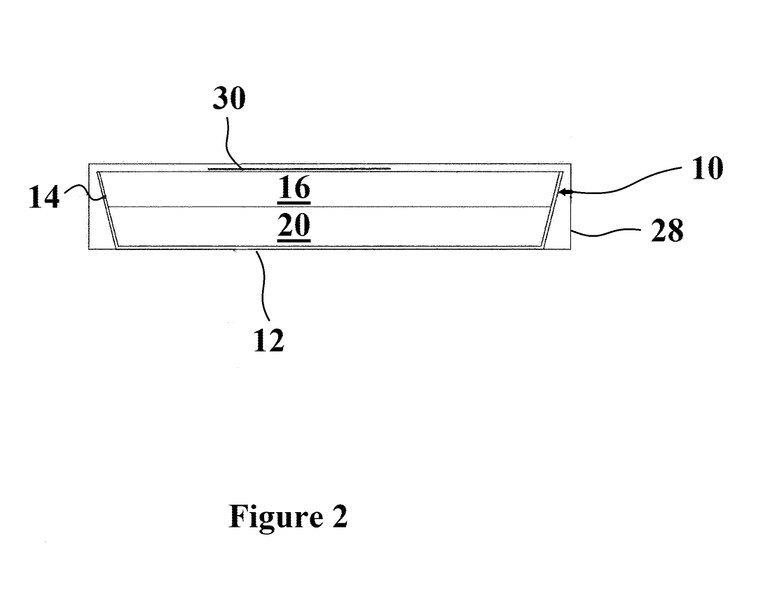

The container 10 is provided beneath a charging vessel 18, from which a volume of pre-mixed and unbaked cake mixture 20 can be charged into the chamber 16 (as can be seen in FIG. 2).

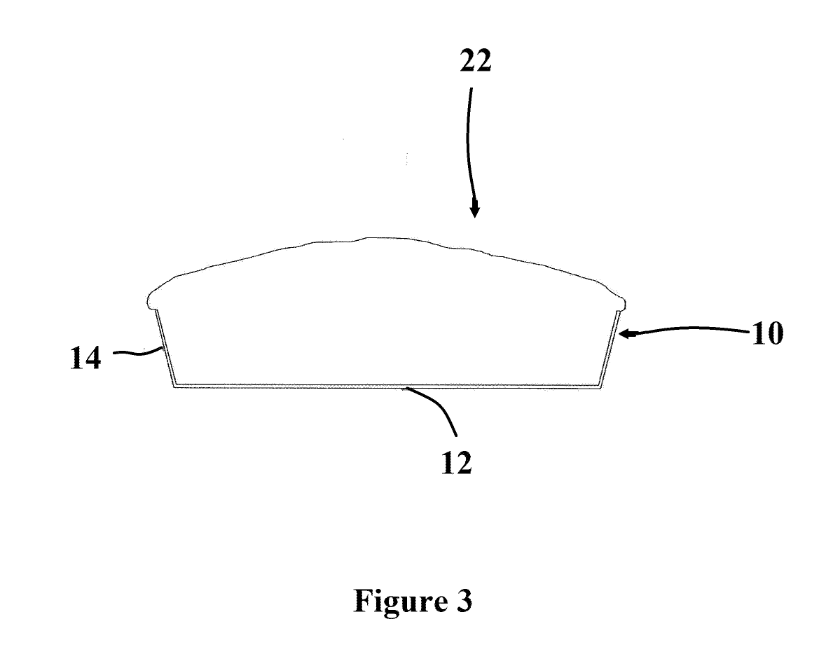

Typically, the cake mixture 20 will be of liquid or other generally pourable consistency. The cake mixture 20 will typically be of a formulation which includes the ingredients necessary to ensure that the container 10 can be placed directly into a heated oven for a predetermined period of time, with the result that the cake mixture 20 will produce a freshly baked cake 22 within said container 10, e.g. as shown in FIG. 3.

The cake mixture 20 will typically be filled to a level below the top of the compartment 16, to leave space for the ingredients to rise and take up at least the remaining space in the container 10 during baking of the ingredients in an oven.

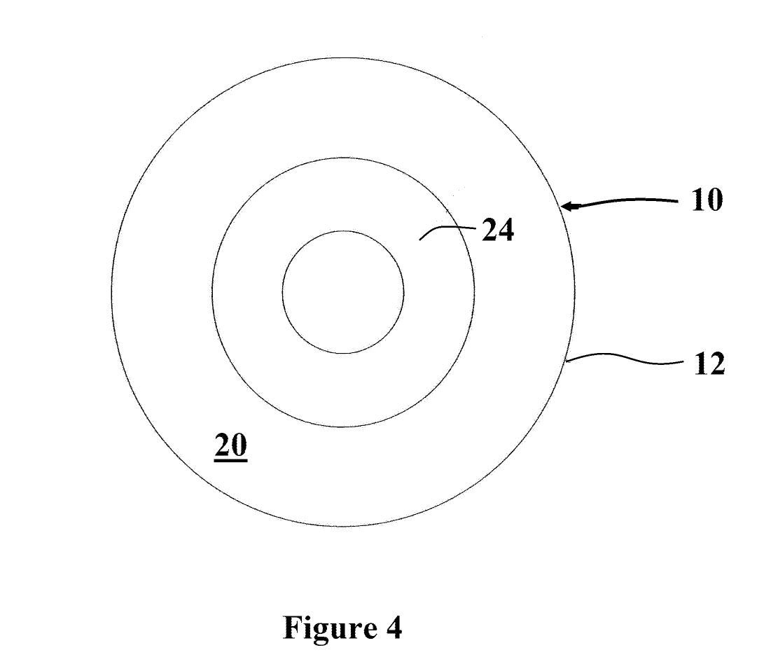

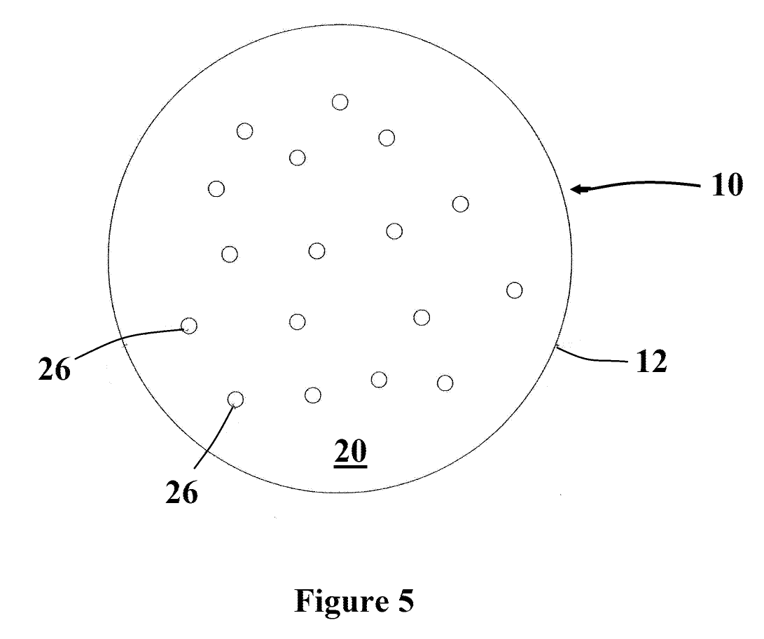

In exemplary embodiments, the cake mixture 20 may include solid or semi-solid ingredients, such as one or more slices of pineapple 24 (as shown in FIG. 4) or pieces/chips of chocolate 26 (as shown in FIG. 5). Other solid ingredients for inclusion in the unbaked cake mixture may include pieces of stem ginger, fruit or confectionary. The subsequent baking process will then cause these ingredients to become an integral part of the freshly baked cake.

Referring back to FIGS. 1 and 2, an exemplary method in accordance with the invention may include the steps of charging the container 10 with unbaked cake mixture at a charging location, wherein the unbaked cake mixture 20 is presented in the container in a state ready for baking in an oven. The charged container 10 may then be packaged for storage at a retail location, e.g. in a box for storage on a shelf in a supermarket. Typically, the retail location will be remote from the charging location and so the packaging may need to be suitable to withstand transportation conditions.

The packaging may take the form of a simple box-type container, e.g. as indicated by reference number 28 in FIG. 2, for presenting the charged container for purchase at said retail location. Preferably, the packaging 28 will be of a form suitable to prevent contamination of the unbaked ingredients in the container prior to purchase. The packaging 28 will usually be removed before placing the charged container 10 in an oven. In exemplary embodiments, the cake mixture within the charged container 10 is sealed against airborne contamination prior to shipping, e.g. using a film or a bag type receptacle to cover the ingredients, prior to locating in the box 28.

In exemplary embodiments, solid or semi-solid ingredients (i.e. those intended to be added to the cake mixture prior to baking) are provided in a separate container. Said separate container may take the form of a sealed pouch or sachet or the like, for example.

In exemplary embodiments, the charged container 10 is packaged with additional ingredients intended to be applied to the unbaked cake mixture prior to baking, e.g. fruit pieces or pieces of confectionary, such as chocolate chips or the like. The additional ingredients may be sealed in a separate container, and said separate container may be stored for transport and retail with said charged container inside common packaging, e.g. a box 28 or like receptacle for enclosing the charged container and said separate container. A separate container for such additional ingredients is shown schematically at 30 in FIG. 2.

The additional ingredients may be frozen prior to transportation of said packaging 28 to said retail location.

Additionally or alternatively, the charged container 10 may be packaged with additional ingredients intended to be applied to the cake after baking, e.g. a cream-type product or icing or sauce/syrup or the like intended to be applied to the upper surface of the cake after baking In exemplary embodiments, such additional ingredients are sealed in a separate container (e.g. as indicated schematically at 30 in FIG. 2), and said separate container 30 is stored for transport and retail with said charged container 10 inside common packaging, e.g. a box 28 or like receptacle for enclosing the charged container and said separate container. Said separate container may take the form of a sealed pouch or sachet or the like, for example. The additional ingredients may be frozen prior to transportation of said packaging to said retail location.

It will be understood that exemplary embodiments of the invention provide a convenient method and apparatus for baking a cake, wherein a container is charged with pre-mixed cake ingredients which are then presented for purchase at a retail location in a form ready for immediate baking in said container without further preparation, e.g. in an oven at a dispensing location remote from the retail location. Typically, the baked cake will be consumed directly from the container 10.

In exemplary embodiments, the container 10 is a single use container, wherein the cake is baked in the container, the cake is dispensed from the container 10 for consumption, and the container 10 is disposed of, e.g. by placing in a refuse container.

In exemplary embodiments, the container 10 is of oven-ready construction and may take the form of a body of paper or board type material. The container 10 may be of a table-ready construction, whereby the cake can be presented for consumption in said container 10 after baking The side wall may be suitably rigid to withstand expansion from the cake batter during baking

In exemplary embodiments, the charged container is frozen (e.g. at the charging location) prior to shipping, whereby the unbaked cake mixture becomes frozen. The charged container may then be shipped to the retail location under frozen conditions, and then stored in frozen or chilled conditions after shipping to the retail location.

In exemplary embodiments, the unbaked mixture is frozen in the container after charging, and the charged container is then transported to the retail location under chilled conditions (e.g. in a chilled compartment forming part of a chilled distribution chain/network). The frozen ingredients are then able to temper from frozen during transportation to the retail location and/or during storage at the retail location, ready for retail in a substantially unfrozen state (e.g. in a chilled cabinet at the retail location, as opposed to a freezer cabinet).

In other embodiments, the unbaked mixture is chilled in the container after charging, the charged container is then transported in a chilled condition to the retail location and stored in a chilled condition at the retail location for retail in a chilled condition.

The consumer may place the charged and chilled container directly in an oven for baking the ingredients from a chilled or ambient state after purchase and removal from the retail location, or may place the container in a freezer for further storage in a frozen state at the baking location.

In exemplary embodiments, the unbaked cake mixture is charged into said container in the form of a raw cake batter.

In exemplary embodiments, the step of charging the container results in only a partial filling of said open chamber with said raw cake batter, such that only a lower portion of the side wall is covered by said raw cake batter and an upper portion of the side wall defines part of a void into which the cake batter can expand during baking In exemplary embodiments, the container has a known volume and the raw cake batter takes up in the region of 80% or less of said volume after charging at said charging location. The partially-filled container is then frozen at said charging location to freeze the raw cake batter in said partially-filled container prior to shipping to said retail location. This avoids unwanted displacement of the raw batter within the container, as well as prolonging shelf-life. However, the partially-filled and frozen container is then shipped to said retail location under chilled conditions. This enables the ingredients to temper over time, to avoid or reduce tempering time required at the retail location ready for presentation of the charged container as a ‘chilled’ product (as opposed to a ‘frozen’ product).

In exemplary embodiments, the base wall of the container is provided with a silicon coating or other means suitable for preventing significant deterioration of the base during storage of the raw cake batter.

In exemplary embodiments, the side wall of the container is provided with a greaseproof coating or other means suitable for promoting ready separation of the cake from the side wall after baking

In exemplary embodiments, the raw cake batter is of a formulation which is edible in a raw, chilled state, at least in small quantities, particularly within a known time period (e.g. within a ‘best before’ date). Hence, exemplary embodiments will include heat treated ingredients which might otherwise provide health concerns if the mixture was consumed raw. In exemplary embodiments, the raw cake batter includes the following ingredients: egg, flour, milk; and wherein each of the above ingredients is provided in a heat-treated or other suitable form prior to mixing together or charging into said container, such that the resultant mixture is edible raw or generally not harmful if eaten raw (i.e. prior to baking)

In exemplary embodiments, the formulation of the raw cake batter is configured to control water activity, for preventing or minimising the migration of water from within the cake batter.

In exemplary embodiments, the raw cake batter includes baking powder or another chemical leavening agent for increasing the volume of the raw cake batter during baking The baking powder/leavening agent is microencapsulated or otherwise configured to remain inactive in the absence of sufficient heat.

The methods and apparatus disclosed herein provide an opportunity for consumers to bake their own cake without the need for preparation of cake ingredients or receptacles for said ingredients. Rather, the charged container can be purchased and then placed in a heated oven for a predetermined period of time at the consumer's home, whereby the unbaked cake mixture is transformed into a fresh oven-baked cake, providing both aesthetic and sensual appeal.

Although described with specific reference to cakes, the invention is equally applicable to desserts of the kind which might be referred to as puddings rather than cakes, e.g. sponge puddings and the like intended to be served hot. For example, in exemplary embodiments, a raw pudding batter (preferably of a formulation which is not harmful if eaten raw) is charged into an oven-ready container at a charging location, wherein the charged container may be placed directly into an oven in order to cook the pudding batter in said container. In exemplary embodiments, the pudding may be consumed directly from the container after cooking said pudding batter. For example, the container may be of table-ready construction, as described above. In exemplary embodiments, the raw pudding batter only partially fills the container at the charging location, and the container and charged ingredients are frozen for storage and/or transportation purposes, prior to retailing in a substantially unfrozen, chilled state. Additional ingredients intended to be added to the pudding batter prior to cooking or to be applied to the pudding after cooking in said container may be provided in a separate container, which is then stored for transport and retail with said charged container inside a common packaging, e.g. a box or like receptacle for enclosing the charged container and said separate container.

1. A method of preparing an oven-baked cake, the method comprising:
providing a container for the baking of a cake in an oven;
charging said container with unbaked cake mixture at a charging location; and
presenting the charged container with said unbaked cake mixture in chilled conditions for purchase at a retail location remote from said charging location prior to baking said unbaked cake mixture in said container in an oven remote from said retail location;
wherein the container is of the kind having a base and a side wall extending up from said base, and defines an open chamber for receiving the unbaked cake mixture;
wherein the unbaked cake mixture is charged into said container as a raw cake batter having a formulation which is edible prior to baking;
wherein the step of charging the container results in only a partial filling of said open chamber with said raw cake batter, such that the raw cake batter occupies only a lower portion of the open chamber and an upper portion of the chamber wall defines a void into which the cake batter can expand during baking;
wherein the partially-filled container is frozen at said charging location to freeze the raw cake batter in said partially-filled container prior to shipping to said retail location;
wherein the partially-filled container is presented for retail at said retail location; and
wherein the chilled, partially filled container is ready to be placed directly in an oven after purchase, for baking said raw cake batter at a baking location remote from said retail location.

2. A method according to claim 1 wherein the partially-filled and frozen container is shipped to said retail location under chilled conditions, and is presented for retail at said retail location is a substantially unfrozen, chilled state.

3. A method according to claim 1 wherein the raw cake batter comprises a formulation which has a substantially gel-like structure under ambient and/or chilled conditions after charging into said container at said charging location.

4. A method according to claim 1 wherein the container is charged with raw cake batter at said charging location in a substantially liquid or pourable state, and wherein the step of freezing said container results in a solidification of the raw cake batter within the container, to avoid undesired displacement of the raw cake batter during shipping to said retail location.

5. A method according to claim 4 wherein the container has a known volume and the raw cake batter takes up in the region of 80% or less of said volume after charging at said charging location.

6. A method according to claim 1 wherein the partially-filled container is placed in sealed packaging prior to shipment to said retail location.

7. A method according to claim 6 wherein the packaged container is purchased at the retail location and the container is placed in an oven at a baking location remote from the retail location after removal of the packaging at said baking location.

8. A method according to claim 7 wherein additional ingredients intended to be added to the cake batter prior to baking or to be applied to the cake after baking in said container are provided in a separate container, which is stored for transport and retail with said charged container inside a common packaging.

9. A method according to claim 1 wherein the base wall of the container is provided with a silicon coating or other means suitable for preventing significant deterioration of the base during storage of the raw cake batter, and the side wall of the container is provided with a greaseproof coating or other means suitable for promoting ready separation of the cake from the side wall after baking

10. A method according to claim 1 wherein the raw cake batter includes the following ingredients: egg, flour, and milk;
wherein each of said ingredients is heat-treated prior to charging into the container.

11. A method according to claim 1 wherein the raw cake batter is configured to control water activity, for preventing or minimizing the migration of water from within the cake batter.

12. A method according to claim 1 wherein the raw cake batter includes baking powder or another chemical leavening agent for increasing the volume of the raw cake batter during baking, and wherein the baking powder/leavening agent is microencapsulated or otherwise configured to remain inactive in the absence of sufficient heat.

13. A method according to claim 1 wherein the container is of a table-ready construction, whereby the cake can be presented for consumption from said container after baking, and wherein side wall is suitably rigid to withstand expansion from the cake batter during baking

14. A method according to claim 13 wherein the container is a single use container, and wherein the unbaked cake mixture is baked in the container and then dispensed from the container, before the container is disposed of

15. A method according to claim 14 wherein the container has a body of paper or board type material.

16. A method according to claim 1 wherein the raw cake batter is presented at said retail location in a state ready for baking in an oven, such that the act of placing the partially-filled container directly in a suitably heated oven for a predetermined time period will convert the raw cake batter into a fresh oven-baked cake in the container.

17. A method according to claim 1 wherein the unbaked cake mixture includes solid or semi-solid ingredients at said charging location, which become an integral part of the oven-baked cake as a result of the baking process.
